(19) United States
(12) Patent Application Publication
(10) Pub. No.: US 2009/0308353 A1
(43) Pub. Date: Dec. 17, 2009

(54) FUEL INJECTOR WITH AN IMPROVED CONTROL VALVE

(76) Inventor: Hans-Christoph Magel, Reutlingen (DE)

Correspondence Address: MICHAEL J. STRIKER, 103 EAST NECK ROAD, HUNTINGTON, NY, 11743, US

(21) Appl. No.: 12/303,008

(22) PCT Filed: Jan. 30, 2008
(86) PCT No.: PCT/EP08/51123

§ 371 Date: Dec. 1, 2008

(30) Foreign Application Priority Data
Mar. 9, 2007 (DE) 10 2007 011 685.5

(51) Int. Cl. F02M 51/00

(52) U.S. Cl. 123/472; 239/585.5

(57) ABSTRACT

The invention relates to a fuel injector (1) for injecting fuel into a combustion chamber of an internal combustion engine, said injector comprising a nozzle needle (4) which moves back and forth in an injector body (2) and/or in a nozzle body (3) in order to release and/or to close at least one injection opening (5) in the nozzle body (3). The movement of the nozzle needle (4) can be controlled by a control valve which co-operates with a control chamber (6). The control valve comprises a valve needle (7) which is guided back and forth and can be moved in relation to a sealing seat (8) in order to ventilate the control chamber (6) in a fuel return (8) when the valve needle (7) is lifted from the sealing seat (8). The valve needle (7) has a differential surface which enables the needle to be subjected to a fuel pressure and held in the direction of the sealing seat (8).

The present invention relates to a fuel injector for injecting fuel into a combustion chamber of an internal combustion engine, which includes an improved control valve according to the type described in greater detail in the preamble of claim 1.

### BACKGROUND INFORMATION

Lift-controlled common rail systems are being used to an increasing extent for fuel injection in direct injection diesel engines. This results in the advantage that the injection pressure may be adjusted according to the load and rotational speed. Fuel injectors that include a solenoid valve are particularly well-suited for effecting the control of the valve needle, the valve needle being controlled directly or indirectly via a control chamber which is placed under high fuel pressure or from which pressure is released. When the control chamber is vented, the valve needle lifts off of the injection openings, thereby enabling the fuel to enter the combustion chamber. The control chamber is acted upon with pressure or it is vented via a control valve which may be switched using an electromagnet. When current is supplied to the electromagnet, a sealing seat is released via a valve needle which is situated such that it may move with reciprocating motion. The sealing seat is released in order to vent the control chamber at least intermittently or for the duration of the injection.

The control valve of the fuel injector of the type in question includes a valve needle which, according to a first embodiment, is cylindrical in design, and which forms—via the end surface—the necessary sealing seat against a valve plate. A further embodiment of the valve needle may be formed by a sleeve which is situated on a pressure pin in a manner such that it may move with a reciprocating motion. Regarding the embodiment of the valve needle as a cylindrical pin, it extends into a valve pressure chamber which is under high fuel pressure when the fuel injector is in the idle state. The valve pressure chamber is vented via a lifting motion of the cylindrical pin, thereby releasing the sealing seat from the valve plate and exposing a spill channel which is centrally located in the sealing seat, thereby enabling the valve pressure chamber to be vented into the spill channel. Given that the cylindrical pin-type valve needle is acted upon with high fuel pressure only via the jacket surface, it is hydraulically force-balanced. Regarding the embodiment of the sleeve-type valve needle, the high fuel pressure is present in the interior of the valve needle. High pressure is therefore also only applied to the wall of the valve needles, and a hydraulically pressure-balanced situation of the valve needle is attained. The spill takes place into a spill chamber which encloses the valve needle on the outside. Furthermore, the valve needle is acted upon by a compression spring which presses the valve needle into the sealing seat. The valve needle is lifted off of the sealing seat when the solenoid coil is activated and the magnetic actuation acts against the spring force. The use of pressure-balanced valve needles makes it possible to use smaller spring forces, smaller magnetic forces, smaller valve lifts, and, therefore, faster switching times. It is also possible to improve the multiple-injection capability.

In the known designs of the valve needle of the control valve, however, the problem results that the force applied by the compression spring on the valve needle must be designed to be relatively great in order to attain the necessary sealing effect. As a result, the electromagnet must also apply greater forces to actuate the valve needle, in order to act against the stiffly-designed compression spring. The result is a control valve which requires a great deal of installation space, since electromagnets with a strong actuation force take up a large amount of installation space. Furthermore, it must be noted that increased wear occurs with a pressure-balanced situation of the valve needle of this type which is acted upon with spring force, since, in the instant of closing, the strong spring force moves the valve needle against the valve plate with relatively high acceleration in order to form the sealing seat. Bounce back behavior also occurs, which is disadvantageous for the control of the valve needle and for the wear of the components involved.

The object of the present invention, therefore, is to create an improved embodiment of the valve needle of the control valve in a fuel injector, which makes it possible to use weaker spring forces of the compression spring to actuate the valve needle, and which makes it possible to use smaller electromagnets.

### DISCLOSURE OF THE INVENTION

This object is attained based on a fuel injector according to the preamble of claim 1 in combination with its characterizing features. Advantageous developments of the present invention are described in the dependent claims.

The present invention is based on the technical teaching that the valve needle includes a differential surface which enables the needle to be subjected to a fuel pressure and held in the direction of the sealing seat. The embodiment of the valve needle according to the present invention utilizes the fact that the differential surface is acted upon by the fuel under high pressure, so that the resultant fluidic force acts as a force to close the valve needle in the direction of the sealing seat. As a result, the compression spring may be designed with less stiffness, thereby resulting in weaker spring forces. The closing force applied by the compression spring is added to the hydraulic closing force applied by the action of pressure being applied by the fuel to the differential surface. When current is supplied to the electromagnet, it must act against a smaller spring force, thereby making it possible to also design the electromagnet smaller in size. Due to the high fuel forces, the differential surface may be relatively small. The valve needle is therefore only somewhat pressure-balanced, and the differential surface serves as a small, closing pressure stage. This makes it possible to optimize the valve timing and improve the multiple-injection capability. Since the hydraulic closing force increases as the pressure increases, the seal integrity of the seal seat of the valve needle is also improved, and no allowances for pressure fluctuations that may occur need be made in the basic design of the control valve. Furthermore, wear is minimized, since, when the operating pressure is low, the valves do not close with high spring forces. The closing force depends on the level of the fuel pressure. When pressure is high, a high closing force is therefore required, and the closing force is automatically increased via the application of force to the differential surface. When fuel pressure is low, the resultant hydraulic force is also manifested as a lower value for pressure application by the valve needle in the seal seat. Furthermore, the switching speed increases when the valve opens, since the hydraulic closing force decreases when the valve starts to open. A larger force is therefore available for acceleration in order to lift the valve needle from the seal seat. This strong opening force which exists despite the use of a small electromagnet makes it possible to attain valve timing with large damping forces at the lift stop. An optimized lifting motion may therefore be attained. The damping behavior that occurs when the valve needle closes in the seal seat may also be improved. Since minimal spring forces are required to close the valve needle, only a small amount of impact energy is released when the valve is set down onto the seal seat on the valve plate. In addition, the hydraulic closing force is applied in the closed state of the needle seat and prevents the valve from reopening.

Due to the one-pieced design of the valve needle and the anchor of the electromagnet with a small moving mass overall, in combination with the differential surface according to the present invention, very short time intervals between individual injections are made possible, since the switching dynamics may be adjusted in an optimal manner, independently of the return conditions of the fuel.

According to a first embodiment of the valve needle, the valve needle is designed in the shape of a cylindrical pin with a pin diameter which transitions—in the region of the end which seals the sealing seat—into a seal diameter which is greater than the pin diameter, to form the differential surface. A first embodiment of the valve needle is therefore presented, the valve needle being designed as a cylindrical pin and providing a seal against the valve plate via the end surface, in the direction of motion. The differential surface results from a larger diameter of the cylindrical pin in the region of the valve pressure chamber which is acted upon with high fuel pressure. Pressure may therefore act in the direction of the valve seat via the annular differential surface.

It is advantageous that the control valve includes a valve piece which abuts a valve pressure chamber, the valve needle being guided in a reciprocating manner at least into the valve piece, and the region of the sealing end of the valve needle extending out of the valve piece and into the valve pressure chamber. The passage of the valve needle through the valve piece is not limited thereto. Instead, in further components, it may be also extend into the electromagnet. The valve piece may include a recess or a cavity, at least intermittently, and it may abut the valve plates. This cavity is used as the valve pressure chamber which is connected via fluid channels to the control chamber in order to control the valve needle. The valve pressure chamber encloses the section of the valve needle which is designed as a cylindrical pin. The valve needle is therefore acted upon with high fuel pressure around its entire circumference via the jacket surface. A spill channel is advantageously formed in the valve plate inside the seal seat concentrically to the extension of the valve needle. When the valve needle lifts off of the seal seat, the valve pressure chamber and, therefore, the control chamber may therefore be vented into the spill channel. The connection of the valve pressure chamber to the control chamber for the purpose of controlling the valve needle may include a throttle in order to attain controlled venting of the valve control chamber. The spill channel is connected to a fuel return in which a much lower fuel pressure is present, thereby making it possible to vent the valve pressure chamber into the spill chamber. The seal seat is designed as an annular seal seat and it encloses the spill channel in a concentric manner. When the end surface of the cylindrical pin-type valve needle is set down, the spill channel may therefore be fluidly separated from the valve pressure chamber.

In a further embodiment of the valve needle, the valve needle is designed in the shape of a sleeve, and a pressure pin with a defined pin diameter extends through the valve needle and guides the valve needle in a sealing manner in the lifting motion. According to the second embodiment of the valve needle, the valve needle encloses a pressure pin which is fixedly situated relative to the injection body. The valve needle includes a borehole into which the pressure pin extends and guides the valve needle in a sealing manner. The pressure pin does not extend via its entire length through the valve needle, although the borehole in the valve needle extends along the entire length of the valve needle. The borehole has a smaller diameter in the region of the seal seat of the valve needle, however. The differential surface—according to the present invention—on the valve needle is therefore formed via the difference between the diameters. According to this embodiment of the fuel injector, the fluidic connection of the control chamber to a pressure chamber inside the valve needle takes place via a fluid channel which extends concentrically to the extension direction of the pressure pin. The fluid channel therefore leads from the valve plate into the center of the seal seat. When the seal seat is closed, the control chamber therefore remains under high pressure. The closed chamber in the valve needle is formed by the valve needle and the end surface of the pressure pin. The valve needle itself is situated inside a spill chamber which forms the low-pressure region and is used, with a spill channel, to return the control quantity of the fuel. When the valve needle lifts off of the seal seat, the fluidic connection between the fluid channel and the spill chamber is established, thereby enabling the fluid channel to vent into the spill chamber and, therefore, into the spill channel. When the current supply to the electromagnet is terminated, the compression spring presses the valve needle against the seal seat once more, thereby eliminating the fluidic connection between the spill chamber and the fluid channel once more. The valve needle has a sealing diameter in the region of the seal seat which is smaller than the pin diameter, and is therefore smaller than the borehole in the valve needle. The differential surface is therefore formed in a manner such that the valve needle is pressed against the seal seat via the application of the high fuel pressure against the differential surface.

Via the two valve needles which have different designs, it is demonstrated that, although, the differential surface may indeed be preferably formed in the region of the fuel high-pressure chamber via a difference in the diameters of the valve needles, the present invention is not limited to creating the differential surface by using a difference between diameters. Instead, any type of geometrical design which exerts a relatively smaller force on the valve needle in order to press it into the seal seat is possible within the scope of the present invention. In addition, the fluid need not necessarily act from the direction of the high-pressure chamber. The differential surface may therefore also extend into the low-pressure region, and an application of pressure by the low pressure may also exert a force on the valve needle. Preferably, however, it is provided that an application of pressure takes place from the high-pressure region.

The control valve of the fuel injector is not limited to the design as a solenoid valve. Instead, it may be designed as a piezo actuator-actuated valve.

Further measures which improve the present invention are described in greater detail below with reference to the figures and in combination with the description of the preferred embodiments of the present invention.

### EXEMPLARY EMBODIMENTS

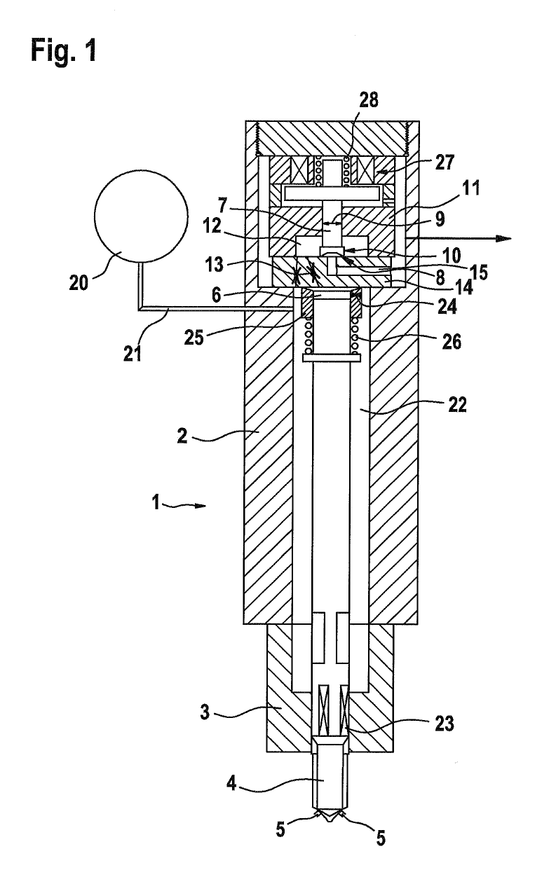

FIG. 1 shows a schematic view of a fuel injector with a cylindrical pin-type design of the valve needle of the control valve; and

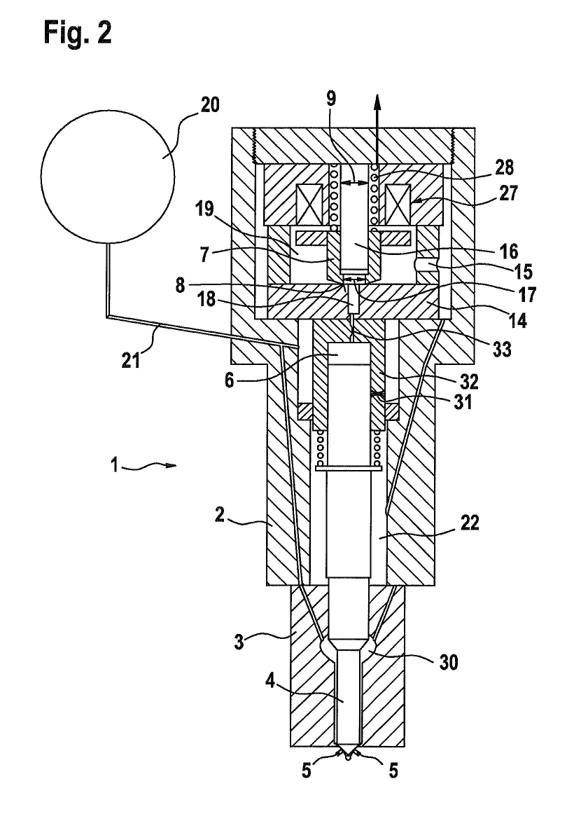

FIG. 2 shows a schematic view of a fuel injector with a valve needle which is designed in the shape of a sleeve and extends around a pressure pin.

FIG. 1 shows a schematic depiction of a fuel injector 1 according to the present invention, in a cross-sectional view. Fuel injector 1 includes an injector body 2 which transitions into a valve body 3. A valve needle 4 is situated in a reciprocating manner inside injector body 2 and nozzle body 3. Injection openings 5 formed in nozzle body 3 are opened when nozzle needle 4 is lifted, in order to inject fuel into a combustion chamber of an internal combustion engine. The fuel is supplied by a high pressure accumulator 20 which delivers the fuel via a high pressure line 21 to a high pressure chamber 22 inside injector body 2 and nozzle body 3. The fuel is directed via channel structure 23 to a region next to injection openings 5. A slight lifting motion of nozzle needle 4 is therefore all that is required to open the injection openings, thereby allowing the fuel to exit injection openings 5. A control chamber 6 is used to control the reciprocating motion of nozzle needle 4. Control chamber 6 may be filled with fuel under high pressure via a throttle 24. Control chamber 6 is limited by an end surface of nozzle needle 4 and by a valve plate 14. Control chamber 6 is limited on the sides via a sealing ring 25 which is pressed via a compression spring 26 against the lower planar surface of valve plate 14.

Valve plate 14 includes a fluidic connection 13 which also includes a throttle. Fluidic connection 13 leads into a valve pressure chamber 12 which is also under high fuel pressure when fuel injector 1 is in the idle state.

Valve pressure chamber 12 is formed by a geometric design inside a valve piece 11. Valve piece 11 abuts valve plate 14, and it is abutted by an electromagnet 27 in the upper region of fuel injector 1. A valve needle 7 extends from valve pressure chamber 12 into electromagnet 27. Valve needle 7 is movable in a reciprocating direction using electromagnet 27. Current does not flow through electromagnet 27 when fuel injector 1 is in the idle state. Valve needle 7 is therefore located in a position in which it abuts a seal seat 8. Seal seat 8 is situated above a surface of valve plate 14. The geometric design of the end of valve needle 7 forms an annular bearing surface against valve plate 14, thereby producing seal seat 8. Valve pressure chamber 12 is therefore sealed off from a spill channel 15 which extends into the center of seal seat 8. When current is supplied to electromagnet 27, valve needle 7 moves via a lifting motion away from valve plate 14, thereby opening seal seat 8. In the opening state formed in this manner, valve pressure chamber 12 may vent into spill channel 15, thereby also venting control chamber 6 via fluidic connection 13. Due to the pressure drop in control chamber 6, nozzle needle 4 may lift off of injection openings 5, thereby resulting in fuel injection. When the current supply to electromagnet 27 is terminated, valve needle 7 moves toward valve plate 14 once more, thereby forming seal seat 8 once more. Valve pressure chamber 12 is placed under high fuel pressure once more, and control chamber 6 is therefore under high pressure once more. Nozzle needle 4 therefore closes once more.

Electromagnet 27 includes a compression spring 28 which applies force to valve needle 7 in the direction of seal seat 8. Valve needle 7 is designed as one piece with an anchor plate 29. Anchor plate 29 and valve needle 7 are therefore both acted upon with force by compression spring 28.

According to the present invention, valve needle 7 has a seal diameter 10 which is greater than pin diameter 9. Pin diameter 9 forms a seal seat in the section inside valve piece 11, thereby resulting in the fluidic seal as well as guidance of valve needle 7 in a reciprocating direction. The seal seat also seals off valve pressure chamber 12 between valve needle 7 and valve piece 1. On the sub-piece of valve needle 7 which extends into valve pressure chamber 12, pressure acts only on the jacket surface, thereby initially resulting in a pressure-balanced situation of valve needle 7. Due to the difference between seal diameter 10 and pin diameter 9, however, a differential surface is formed on valve needle 7, which applies force to valve needle 7 in the direction of seal seat 8. Via the application of high pressure on the differential surface inside valve pressure chamber 12, valve needle 7 is moved with a force into seal seat 8 and is held therein. Compression spring 28 is therefore designed with only a slight amount of stiffness. Furthermore, electromagnet 27 is correspondingly small in design, since it need only act against a slight spring force of compression spring 28. For valve needle 7 to be lifted off of seal seat 8, the force resulting from the differential surface to which force is applied must be overcome, but this force is no longer applied as the lift of valve needle 7 continues. Electromagnet 27 therefore need not act against a fluidic force. According to the present invention, therefore, the dynamic behavior of valve needle 7 is optimized, thereby making it possible to use a compression spring 28 with smaller spring forces. An electromagnet 27 with smaller magnetic forces is therefore also sufficient.

FIG. 2 shows a further embodiment of a fuel injector according to the present invention, which is also depicted schematically and in a cross-sectional view. The fuel injector includes an injector body 2 which transitions into a valve body 3. Valve needle 4 extends inside injector body 2 and nozzle body 3. Nozzle needle 4 comes to bear against injection openings 5 inside nozzle body 3, thereby allowing fuel which is delivered to nozzle body 3 from a high pressure accumulator 20 via a high pressure line 21 to exit through injection openings 5. The fuel is initially guided via high pressure line 21 or connected high pressure channels into a collecting chamber 30 which is then under high fuel pressure. When nozzle needle 4 is lifted off of injection openings 5, they are opened and fuel may enter the combustion chamber.

The reciprocating motion of nozzle needle 4 is controlled via a control chamber 6 which is limited by the end surface of nozzle needle 4. Nozzle needle 4 is guided through a guide body 32 in which a throttle 31 is installed. High pressure fuel enters control chamber 6 via throttle 31, thereby enabling control chamber 6 to fill with fuel under high pressure. Control chamber 6 is connected via a fluid channel 18 to the control valve of fuel injector 1, thereby enabling control chamber 6 to be vented temporarily. A further throttle 33 is installed in fluid channel 18 in order to limit the magnitude of the fuel flow inside fluid channel 18, and, therefore to control the speed of the reciprocating motion of nozzle needle 4.

The control valve includes an electromagnet 27, which is used to control a valve needle 17. When current is supplied to electromagnet 27, valve needle 7 is set into a lifting motion against the spring force of a compression spring 28. According to the present embodiment, valve needle 7 is sleeve-shaped in design, and a borehole extends through valve needle 7. A pressure pin 16 is installed in the borehole. Pressure pin 16 is statically connected to electromagnet 27 and is installed in injector body 2. Pressure pin 16 extends only via a subregion into valve needle 7. The continuous bore inside valve needle 7 therefore forms a chamber which is limited by the end surface of pressure pin 16. Fluid channel 18 extends concentrically to pressure pin 16 into the chamber formed inside the valve needle. Valve needle 7 may be brought to bear against valve plate 14, thereby forming a seal seat 8. When current is not supplied to electromagnet 27, compression spring 28 presses valve needle 7 against valve plate 14, thereby forming seal seat 8. Valve needle 7 is situated inside a spill chamber 19 which is connected to a spill channel 15 and is therefore not under fuel high pressure. When valve needle 7 lifts off of seal seat 8 when current is supplied to electromagnet 27, control chamber 6 may therefore be vented via fluid channel 18. When the current supply to electromagnet 27 is terminated, compression spring 28 presses valve needle 7 against the boundary surface of valve plate 14 once more, thereby forming seal seat 8 and separating fluid channel 18 from spill chamber 19 once more.

The geometric design of valve needle 7 in the region of the borehole includes a seal diameter 17 which is smaller than the pin diameter 9 of pressure pin 16. This results in the differential surface according to the present invention, which is acted upon by the high pressure fuel. The differential surface is designed in a manner such that valve needle 7 is pressed against seal seat 8 by the application of fluidic pressure. Compression spring 28 is therefore supported in its application of force, thereby making it possible to design it and electromagnet 27 smaller in size, also in accordance with this embodiment of fuel injector 1, and to thereby attain the advantages mentioned above.

The design of the present invention is not limited to the preferred embodiment described above. Instead, a number of variants which utilize the solution presented, including those with basically different designs, is feasible. It is feasible, for example, to also use the solution according to the present invention for other components which are used in high pressure applications and which require similar control valves. All control valves of this type which are used to inject fuel into a combustion chamber include the valve needle which is guided in a reciprocating manner, it being possible to move the valve needle against a sealing seat in order to vent pressure from a compression chamber into a fuel return when the valve needle is lifted off of the seal seat. The valve needle includes the differential surface via which it may be acted upon with the fuel pressure and held in the direction of the seal seat.

What is claimed is:

1. A fuel injector (1) for injecting fuel into a combustion chamber of an internal combustion engine, which includes a nozzle needle (4) which moves with reciprocating motion in an injector body (2) and/or in a nozzle body (3) in order to open and/or close at least one injection opening (5) in the nozzle body (3); the movement of the nozzle needle (4) is controllable via a control valve which interacts with a control chamber (6), the control valve including a valve needle (7) which is guided with a reciprocating motion and which is movable relative to a sealing seat (8) in order to vent the control chamber (6) into a fuel return (8) when the valve needle (7) is lifted off of the sealing seat (8),
wherein
the valve needle (7) has a differential surface which enables the needle to be subjected to a fuel pressure and held in the direction of the sealing seat (8).

2. The fuel injector (1) as recited in claim 1,
wherein
the valve needle (7) is designed in the shape of a cylindrical pin with a pin diameter (9) which transitions—in the region of the end which seals the sealing seat (8)—into a seal diameter (10) which is greater than the pin diameter (9), to form the differential surface.

3. The fuel injector (1) as recited in claim 1,
wherein
the control valve includes a valve piece (11) which abuts a valve pressure chamber (12), the valve needle (7) extending at least into the valve piece (11), and the region of the sealing end of the valve needle (7) extending out of the valve piece (11) and into the valve pressure chamber (12).

4. The fuel injector (1) as recited in claim 1,
wherein
the valve pressure chamber (12) is fluidly connected to the control chamber (6), the fluidic connection (13) being formed in a valve plate (14) which serves as the sealing seat (8).

5. The fuel injector (1) as recited in claim 1, wherein
a spill channel (15) is formed in the valve plate (14) inside the sealing seat (8) concentrically to the extension of the valve needle (7), so that, when the valve needle (7) is lifted off of the sealing seat (8), the valve pressure chamber (12) and, therefore, the control chamber (6) may be vented into the spill channel (15).

6. The fuel injector (1) as recited in claim 1,
wherein
the valve needle (7) is designed in the shape of a sleeve, and a pressure pin (16) with a pin diameter (9) extends through the valve needle (7), and the valve needle (7) is guided onto the pressure pin (16) in a sealing manner.

7. The fuel injector (1) as recited in claim 6,
wherein
the pin diameter (9) is larger than the sealing diameter (17) formed on the valve needle (7), in order to form the differential surface.

8. The fuel injector (1) as recited in claim 6 or 7, wherein
a fluid channel (18) which is fluidly connected to the control chamber (6) may be sealed off from a spill chamber (19) using the sealing seat (8) which is operatively connected to the valve needle (7), the valve needle (7) being accommodated in the spill chamber (19).

9. The fuel injector (1) as recited in claim 1, wherein
the control valve is designed as a solenoid valve.

10. The fuel injector (1) as recited in claim 1,
wherein
the control valve is designed as a piezo actuator-actuated valve.
